(19) United States
(12) Patent Application Publication
(10) Pub. No.: US 2022/0012839 A1
(43) Pub. Date: Jan. 13, 2022

(54) IMAGE PROCESSING APPARATUS, CONTROL METHOD OF IMAGE PROCESSING APPARATUS, AND CONTROL PROGRAM

(71) Applicant: FUJIFILM Corporation, Tokyo (JP)

(72) Inventors: Taro SAITO, Saitama (JP); Masahiro TERADA, Saitama (JP); Satoru WAKABAYASHI, Saitama (JP); Tetsuya MIZUSAWA, Saitama (JP)

(73) Assignee: FUJIFILM Corporation, Tokyo (JP)

(21) Appl. No.: 17/482,437

(22) Filed: Sep. 23, 2021

Related U.S. Application Data
(63) Continuation of application No. PCT/JP2020/013463, filed on Mar. 25, 2020.

(30) Foreign Application Priority Data
Mar. 28, 2019 (JP) 2019-064783

(51) Int. Cl. G06T 1/00; H04N 1/32

(52) U.S. Cl. CPC G06T 1/0007; H04N 2201/3274; G06T 2210/32; H04N 1/32128

(57) ABSTRACT

Provided is an image processing apparatus that performs image processing on original image data based on an instruction from a terminal, the apparatus including a communication unit that performs communication with the terminal, and a processor, in which the processor acquires the original image data, performs the image processing as instructed by the terminal on the original image data, and performs, in a case in which one instruction affects another instruction among a plurality of the instructions with respect to the original image data, control of not performing the image processing in accordance with an instruction that affects a highest priority instruction.

### CROSS-REFERENCE TO RELATED APPLICATIONS

This application is a continuation application of International Application No. PCT/JP2020/013463, filed Mar. 25, 2020, the disclosure of which is incorporated herein by reference in its entirety. Further, this application claims priority from Japanese Patent Application No.2019-064783, filed Mar. 28, 2019, the disclosure of which is incorporated herein by reference in its entirety.

### BACKGROUND OF THE INVENTION

### 1. Field of the Invention

The present disclosure relates to an image processing apparatus, a control method of an image processing apparatus, and a control program.

### 2. Description of the Related Art

There is a demand for collaborative editing on RAW image data with a team of a plurality of editors. As the technology for responding to such a demand, a system capable of collaborative editing of one image data has been proposed (see WO2005/093593A).

### SUMMARY OF THE INVENTION

An object of the present disclosure is to provide an image processing apparatus, a control method of an image processing apparatus, and a control program, which have the improved convenience in a case in which collaborative editing of image data is performed.

An aspect of the present disclosure relates to an image processing apparatus that performs image processing on original image data based on an instruction from a terminal, the apparatus comprising a communication unit that performs communication with the terminal, and a processor, in which the processor acquires the original image data, performs the image processing as instructed by the terminal on the original image data, and performs, in a case in which one instruction affects another instruction among a plurality of the instructions with respect to the original image data, control of not performing the image processing in accordance with an instruction that affects a highest priority instruction.

In the image processing apparatus according to the above aspect, the highest priority instruction may be an earliest instruction.

Further, in the image processing apparatus according to the above aspect, the highest priority instruction may be an instruction from the terminal set to a highest priority.

Further, it is preferable that the image processing apparatus according to the above aspect further comprise a storage that stores a history of the instruction for the image processing on the original image data, in which the processor performs the image processing based on the history stored in the storage.

Further, it is preferable that in the image processing apparatus according to the above aspect, the processor change order of performing the image processing based on the history stored in the storage.

Further, it is preferable that in the image processing apparatus according to the above aspect, the processor perform a plurality of the same types of the image processing in one image processing based on the history stored in the storage.

Further, in the image processing apparatus according to the above aspect, in a case in which the terminal issues a prohibition instruction to prohibit specific image processing on the original image data, the processor may perform control of prohibiting the specific image processing, for which the prohibition instruction is issued, on the original image data.

Further, in the image processing apparatus according to the above aspect, in a case in which the terminal issues an instruction of specific image processing on the original image data and an instruction of relation image processing having relevance to the specific image processing is stored in the history, the processor may transmit caution information to the terminal which transmits the instruction of the specific image processing.

Further, in the image processing apparatus according to the above aspect, the original image data may be RAW image data, and the image processing performed by the processor may include development treatment on the RAW image data.

Another aspect of the present disclosure relates to a control method of an image processing apparatus that performs image processing on original image data based on an instruction from a terminal, the method comprising a communication step of performing communication with the terminal, an acquisition step of acquiring the original image data, an image processing step of performing the image processing as instructed by the terminal on the original image data, and a control step of performing, in a case in which one instruction affects another instruction among a plurality of the instructions with respect to the original image data, control of not performing the image processing in accordance with an instruction that affects a highest priority instruction.

Still another aspect of the present disclosure relates to a control program that controls an image processing apparatus that performs image processing on original image data based on an instruction from a terminal, the program causing a computer to execute a communication step of performing communication with the terminal, an acquisition step of acquiring the original image data, an image processing step of performing the image processing as instructed by the terminal on the original image data, and a control step of performing, in a case in which one instruction affects another instruction among a plurality of the instructions with respect to the original image data, control of not performing the image processing in accordance with an instruction that affects a highest priority instruction.

According to the present disclosure, it is possible to provide the image processing apparatus, the control method of the image processing apparatus, and the control program, which have the improved convenience in a case in which collaborative editing of image data is performed.

### BRIEF DESCRIPTION OF THE DRAWINGS

FIG. 1 is a diagram showing a schematic configuration of an image editing system to which an image processing apparatus according to a first embodiment of the present disclosure is applied.

FIG. 2 is a diagram showing a schematic configuration of the image processing apparatus according to the first embodiment of the present disclosure.

FIG. 3 is a flowchart describing a process flow when the image processing apparatus according to the first embodiment of the present disclosure receives an instruction of image processing.

FIG. 4 is an explanatory diagram of a history of the instruction in the image processing apparatus according to the first embodiment of the present disclosure.

FIG. 5 is a flowchart describing a process flow at the time of RAW image data development by the image processing apparatus according to the first embodiment of the present disclosure.

FIG. 6 is a diagram showing an example of screen display at the time of the image processing by an image processing apparatus according to a second embodiment of the present disclosure.

FIG. 7 is an explanatory diagram of a list of prohibition of the image processing by the image processing apparatus according to the second embodiment of the present disclosure.

FIG. 8 is a flowchart describing a process flow when the image processing apparatus according to the second embodiment of the present disclosure receives the instruction of the image processing.

FIG. 9 is a flowchart describing a process flow when an image processing apparatus according to a third embodiment of the present disclosure receives the instruction of the image processing.

FIG. 10 is a diagram showing an example of screen display at the time of the image processing by the image processing apparatus according to the third embodiment of the present disclosure.

### DESCRIPTION OF THE PREFERRED EMBODIMENTS

### First Embodiment

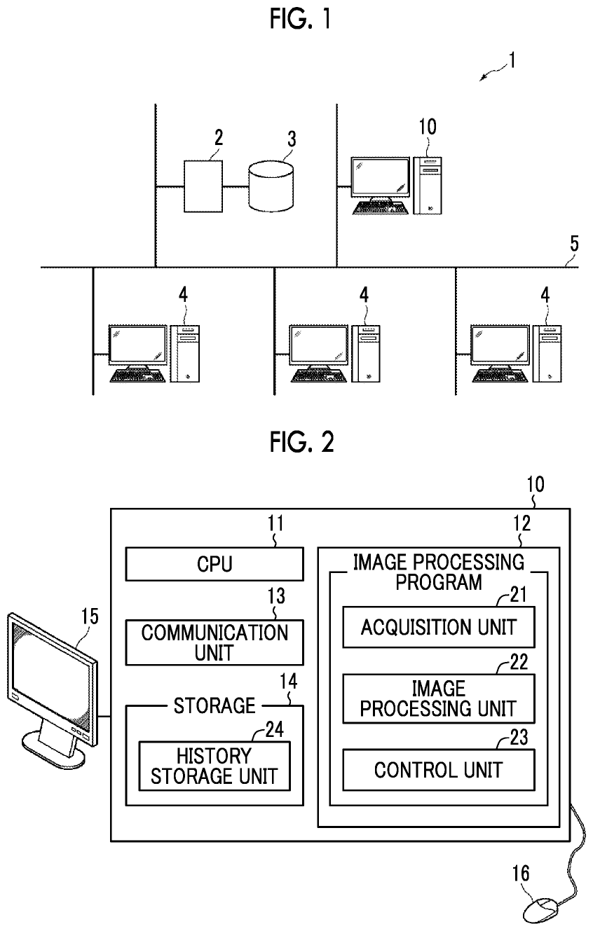

Hereinafter, embodiments of the present disclosure will be described with reference to the figures. FIG. 1 is a diagram showing a schematic configuration of an image editing system 1 to which an image processing apparatus 10 according to a first embodiment of the present disclosure is applied. The image editing system 1 shown in FIG. 1 is a system capable of performing simultaneously editing operation with respect to one RAW image data (corresponding to original image data) from terminals respectively used by a plurality of editors.

As shown in FIG. 1, the image editing system 1 is configured by connecting the image processing apparatus 10, an image server 2, an image database 3, and a plurality of terminals 4 so as to be able to communicate with each other via a network 5.

Each device is a computer in which an application program that functions as a component of the image editing system 1 is installed. The application program is recorded in a recording medium, such as a digital versatile disc (DVD) or a compact disc read only memory (CD-ROM) and distributed, and is installed in the computer from the recording medium. Alternatively, the application program is stored in a storage device of a server computer connected to the network or in a network storage in a state in which the application program is accessible from the outside, and is downloaded and installed in the computer as necessary.

The image server 2 is a device in which a software program that provides a database management system (DBMS) function is installed in a general-purpose computer that has a relatively high processing capacity. Further, the image server 2 comprises a large-capacity storage in which the image database 3 is configured. This storage may be a large-capacity hard disk device connected to the image server 2 via a data bus, or may be a disk device connected to a network attached storage (NAS) and a storage area network (SAN) connected to network 5. Further, the image server 2 arranges the RAW image data received via the network 5 in a format for a database and registers the RAW image data in the image database 3.

The image processing apparatus 10 and the image server 2 are connected to the terminal 4 via the network 5, such as the Internet, and appear to be present above the clouds from the terminal 4. Therefore, the image processing apparatus 10, the image server 2, and the like connected via the network 5 are called a cloud. In the present specification, in the following, the image processing apparatus 10 and the image server 2 will be referred to as the cloud.

In a case in which the image server 2 receives a viewing request from the image processing apparatus 10 via the network 5, the image server 2 searches for the RAW image data registered in the image database 3 and transmits the extracted RAW image data to the image processing apparatus 10 as a request source.

The terminal 4 is a computer used by the editor to edit the RAW image data, and includes a processing device, a high-definition display, and an input device, such as a keyboard and a mouse. In the terminal 4, with respect to the image processing apparatus 10, each process, such as the viewing request of a display image corresponding to the RAW image data, display of an edit screen for editing the RAW image data, and an instruction of the image processing on the RAW image data, is performed by executing a software program for each process. Note that the terminal 4 is not limited to the computer, but may be a tablet, a smart phone, or the like.

The network 5 is the Internet line that connects various devices. Note that the network 5 may be a wired or wireless local area network or may be connected by a dedicated line.

In the following, the image processing apparatus 10 according to the present embodiment will be described in detail. The image processing apparatus 10 is an apparatus in which a control program of the present embodiment is installed in one computer. The computer can be, for example, the server computer connected to the terminal 4 used by the editor to edit the RAW image data via the network 5. The control program is recorded on the recording medium, such as the DVD, the CD-ROM, or the like and distributed, and is installed in the computer from the recording medium. Alternatively, the control program is stored in a storage device of a server computer connected to the network or in a network storage in a state in which the application program is accessible from the outside, and is downloaded and installed in the computer as necessary.

FIG. 2 is a diagram showing a schematic configuration of the image processing apparatus 10 according to the first embodiment of the present disclosure, which is realized by installing the control program in the computer. As shown in FIG. 2, the image processing apparatus 10 comprises a central processing unit (CPU) 11, a memory 12, and a storage 14, as a configuration of a standard workstation. Also, the image processing apparatus 10 is connected with a display 15, such as a high-definition liquid crystal display, and an input unit 16, such as a keyboard or a mouse.

The control program is stored in the memory 12. The control program defines, as the processes executed by the CPU 11, a communication step of performing communication with the terminal 4 via the communication unit 13, an acquisition step of acquiring the original image data, an image processing step of performing the image processing as instructed by the terminal 4 on the original image data, and a control step of performing, in a case in which one instruction affects another instruction among a plurality of the instructions with respect to the original image data, control of not causing the image processing unit to perform the image processing in accordance with an instruction that affects a highest priority instruction. The CPU 11 executes the processes in accordance with the program, so that the computer functions as an acquisition unit 21, an image processing unit 22, and a control unit 23.

Note that in the present embodiment, the CPU 11 executes the function of each unit by the control program, but as a general-purpose processor that executes software and functions as various processing units, in addition to the CPU 11, a programmable logic device (PLD), which is a processor of which a circuit configuration can be changed after manufacturing, such as a field programmable gate array (FPGA) or the like, can be used. Also, the process of each unit may be executed by a dedicated electric circuit or the like, which is a processor having a circuit configuration specially designed to execute a specific process, such as an application specific integrated circuit (ASIC).

One processing unit may be configured by one of these various processors or may be configured by a combination of two or more processors of the same types or different types (for example, a plurality of the FPGAs or a combination of the CPU and the FPGA). In addition, a plurality of the processing units may be configured by one processor. As an example of configuring the plurality of processing units by one processor, first, as represented by a computer, such as a client and a server, there is a form in which one processor is configured by a combination of one or more CPUs and software and this processor functions as the plurality of processing units. Second, as represented by a system on chip (SoC), there is a form in which a processor is used in which the functions of the entire system including the plurality of processing units are realized by a single integrated circuit (IC) chip. As described above, the various processing units are configured by one or more of the various processors described above as a hardware structure.

Further, the hardware structures of these various processors are, more specifically, an electric circuit (circuitry) in which circuit elements, such as semiconductor elements, are combined.

A communication unit 13 realizes communication with an external apparatus via the network 5. The communication unit 13 comprises at least one of a wired communication unit or a wireless communication unit. The wired communication unit comprises, for example, a wired communication module configured by an electric circuit that performs wired communication and a jack that connects a wired cable. The wireless communication unit comprises, for example, a wireless communication module configured by an electric circuit that performs wireless communication and an antenna that transmits and receives radio waves.

The storage 14 comprises the storage device, such as a hard disk, a solid state drive (SSD), or the like. The storage 14 functions as a history storage unit 24 that stores a history of the instruction for the image processing from the terminal 4.

### Process Flow

Next, a process performed in the present embodiment will be described. First, in a case in which the image processing apparatus 10 receives a start instruction of the image processing from the terminal 4, the acquisition unit 21 acquires the RAW image data from the image server 2 via the communication unit 13. The image processing unit 22 develops the RAW image data in accordance with a preset initial parameter and displays the developed RAW image data on the terminal 4 as a preview image.

In this state, the terminal 4 can perform various image processing on the RAW image data. Further, it is possible to simultaneously perform the image processing on the RAW image data designated herein from another terminal 4.

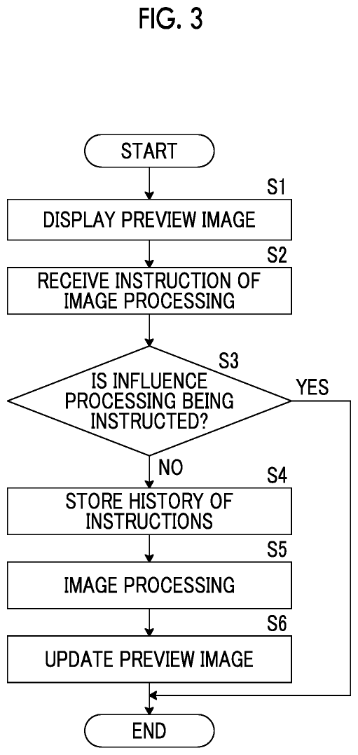

Here, a process flow when the image processing apparatus 10 receives the instruction of the image processing from each terminal 4 will be described. FIG. 3 is a flowchart describing a process flow when the image processing apparatus 10 according to the first embodiment receives the instruction of the image processing.

First, the image processing unit 22 develops the RAW image data in accordance with the preset initial parameter and displays the developed RAW image data on the terminal 4 as the preview image (step S1). Thereafter, in a case in which the instruction of the image processing is received in the image processing apparatus 10 from the terminal 4, the control unit 23 receives the instruction of the image processing from the terminal 4 (step S2), and performs determination whether the image processing that affects this instruction (that is, influence processing) is being currently instructed by another terminal 4 (step S3).

A case in which one instruction affects another instruction among a plurality of the instructions with respect to the RAW image data means processing in which a result of one image processing affects a result of the other image processing even in a case of the same types of the image processing or different types of the image processing. Where, even in a case in which it is the image processing of the same type, it is not considered that one instruction affects another instruction in a case in which the image processing is performed on regions different from each other.

For example, in a case in which color adjustment instructions are simultaneously issued from the plurality of terminals 4, the results of the image processing affect each other and correct adjustment cannot be performed. Where, in a case in which the color adjustment instructions are issued from the plurality of terminals 4 to regions different from each other, it is not considered that one instruction affects another instruction.

Further, even in a case of the different types of the image processing, for example, in a case in which region selection and resizing are simultaneously performed, there is a problem that the selected region is shifted. Further, in a case in which brightness adjustment and tone adjustment are simultaneously performed, both adjustments are the image processing in which brightness is adjusted, the results of the image processing affect each other and the correct adjustment cannot be performed. Further, in a case in which the region selection and crop are simultaneously performed, there is a problem that the selected region disappears. Further, in a case in which the resizing and the crop are simultaneously performed, there is a problem that the crop range is shifted. Further, in a case in which blurring processing and contour enhancement processing are simultaneously performed, the objectives of the processing are opposite to each other, so that the correct adjustment cannot be performed. As in these examples, a combination of the image processing, which causes the problems by being combined and simultaneously performed, is regarded as processing in which the result of one image processing affects the result of another image processing even in a case of the different types of the image processing.

In a case in which it is determined in step S3 that the image processing that affects the instruction of the image processing received in step S2 is currently instructed by another terminal 4 (determination result Yes), the control unit 23 performs control of not causing the image processing unit 22 to perform the image processing in accordance with the instruction that affects the highest priority instruction and causing the image processing unit 22 to terminate the image processing in accordance with the instruction from the terminal 4. Note that in the present embodiment, the highest priority instruction is the earliest instruction (that is, the image processing instruction that is in a state in which editing is possible at the earliest timing).

Here, the “highest priority instruction” means only the instruction received by the image processing unit 22 in a case in which the plurality of instructions of the image processing, which affect each other, are simultaneously issued. Further, the “instruction of the image processing” means including the entire period from when the instruction of the image processing is in the state in which editing is possible until the instruction is confirmed. For example, it can be a period from a state in which an edit window of the image processing is displayed until an OK button or a cancel button in the window is selected. Further, “a case in which the plurality of instructions of the image processing, which affect each other, are simultaneously issued” means a state in which the periods of the plurality of instructions of the image processing, which affect each other, are overlapped.

In a case in which it is determined in step S3 that the image processing that affects the instruction of the image processing received in step S2 is not being currently instructed by another terminal 4 (determination result No), the control unit 23 performs a process of storing the instruction of the image processing received in step S2 in the history of the instruction (step S4).

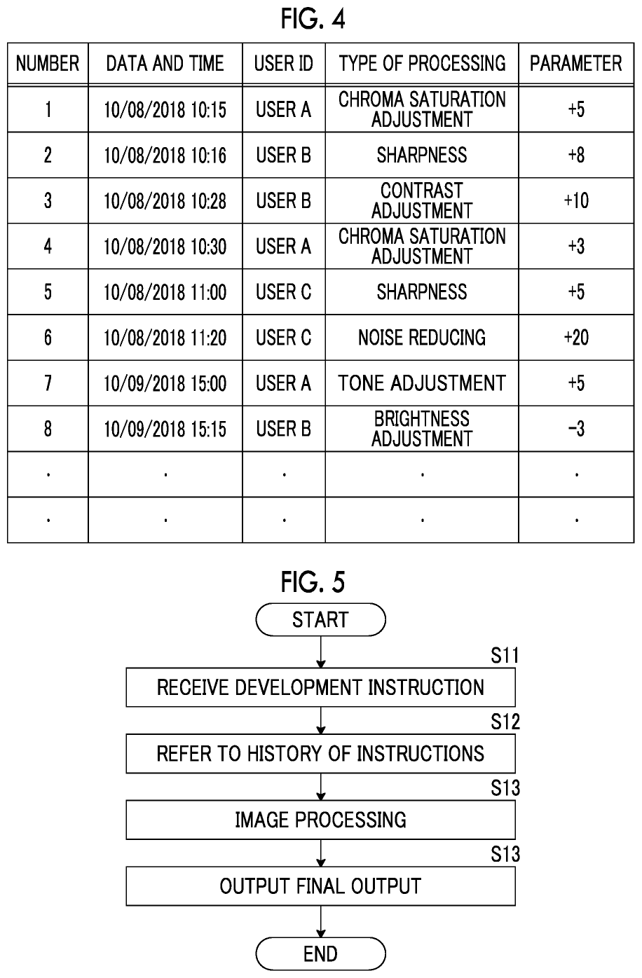

FIG. 4 is an explanatory diagram of the history of the instruction in the image processing apparatus 10 according to the first embodiment. As shown as an example in FIG. 4, the history of the instruction includes five items of a history number, the date and time when the instruction is issued, a user ID that issues the instruction, a type of the image processing, and a content of the parameter of the image processing. In step S4, the process is performed in which the instructions of the image processing received in step S2 are stored in the history storage unit 24 in a time series as a history.

Next, the image processing unit 22 performs the image processing on the RAW image data based on the instruction of the image processing received in step S2 (step S5), updates the preview image to the content that reflects the image processing, and displays the updated preview image on the terminal 4 (step S6), and the process is terminated.

Next, a process when final output after collaborative editing is output will be described. FIG. 5 is a flowchart describing a process flow when the image processing apparatus 10 according to the first embodiment performs RAW image data development.

First, in a case in which the image processing apparatus 10 receives an instruction of development treatment on the RAW image data from the terminal 4, the control unit 23 receives the instruction of the development treatment from the terminal 4 (step S11), refers to the history of the instruction of the image processing stored in the history storage unit 24 (step S12), and performs control of causing the image processing unit 22 to perform the image processing based on the history (step S13).

In step S13, specifically, the control unit 23 controls the image processing unit 22 so as to perform demosaicing processing for developing the RAW image data and image processing corresponding to all the instructions recorded in the history on the RAW image data.

In this case, the control unit 23 may perform control of changing the order in which the image processing unit 22 performs the image processing based on the history stored in the history storage unit 24. For example, as shown in the history of FIG. 4, in a case in which the instructions are issued in the order of sharpness and noise reducing, high quality output can be obtained by performing noise reducing before sharpness that emphasizes noise. In addition, in a case in which joint photographic experts group (JPEG) image data of YCrCb (Y: brightness, Cr: red color difference, Cb: blue color difference) is created from red green blue (RGB) RAW image data, high quality noise reducing can be realized by performing noise reducing by using the RAW image data with a large amount of information.

Further, the control unit 23 may perform control of causing the image processing unit 22 to perform a plurality of the same types of image processing in one image processing based on the history stored in the history storage unit 24. For example, as shown in the history of FIG. 4, in a case in which chroma saturation adjustment is performed a plurality of times, an amount of processing in the image processing unit 22 can be suppressed by adding up the adjustment parameter and collecting the chroma saturation adjustments at one time, so that the time until the final output is output can be shortened.

The image processing unit 22 performs the demosaicing processing for developing the RAW image data and the image processing corresponding to all the instructions recorded in the history and outputs the final output (step S14), and the process is terminated.

### Operation and Effect

In the image processing apparatus 10 according to the present embodiment, in a case in which it is determined that the image processing that affects the instruction of the image processing from the terminal 4 is currently instructed by another terminal 4, the control unit 23 performs control of not causing the image processing unit 22 to perform the image processing in accordance with the instruction that affects the highest priority instruction and causing the image processing unit 22 to terminate the image processing in accordance with the instruction from the terminal 4, so that the convenience in a case in which collaborative editing of the image data is performed can be improved. For example, in a case in which collaborative editing of the image data is performed, it is possible to avoid unnecessary conflicts between the editors and perform the work.

Further, by performing control of not causing the image processing unit 22 to perform the image processing in accordance with the instruction that affects the earliest instruction, the control unit 23 can perform the control that reflects the first-come-first-served order of the instructions.

Note that the control unit 23 may perform control of not causing the image processing unit 22 to perform the image processing in accordance with the instruction that affects the instruction from the terminal 4 set to the highest priority. Here, the “terminal 4 set to the highest priority” may be a terminal in which the highest priority is set in a case in which the priority is set in the terminal itself, or a terminal used by the user ID set to the highest priority in a case in which the priority is set in the user ID. With such an aspect, control that reflects the priority of the editor can be performed.

Further, the image processing apparatus 10 according to the present embodiment comprises the history storage unit 24 that stores the history of the instruction of the image processing on the RAW image data, in which the control unit 23 performs control of causing the image processing unit 22 to perform the image processing based on the history stored in the history storage unit 24. In a case in which the image processing is sequentially repeated on the image data developed from the RAW image data, the image quality may deteriorate. On the other hand, as described above, by collectively performing the image processing on the RAW image data after collaborative editing, the image processing can be performed without causing deterioration in the image quality.

Further, the image quality of the final output can be improved by performing control, by the control unit 23, to change the order in which the image processing unit 22 performs the image processing based on the history stored in the history storage unit 24.

Further, the control unit 23 performs control of causing the image processing unit 22 to perform a plurality of the same types of the image processing in one image processing based on the history stored in the history storage unit 24, so that the time until the final output is output can be shortened.

### Second Embodiment

Hereinafter, a second embodiment of the present disclosure will be described. In the following, the difference from the first embodiment will be mainly described, and the description of the contents overlapping with the first embodiment will be omitted.

The difference between the second embodiment and the first embodiment is that, in a case in which the terminal 4 issues a prohibition instruction to prohibit specific image processing on the RAW image data, the control unit 23 of the image processing apparatus 10 according to the second embodiment further performs control of prohibiting the specific image processing, for which the prohibition instruction is issued, on the RAW image data.

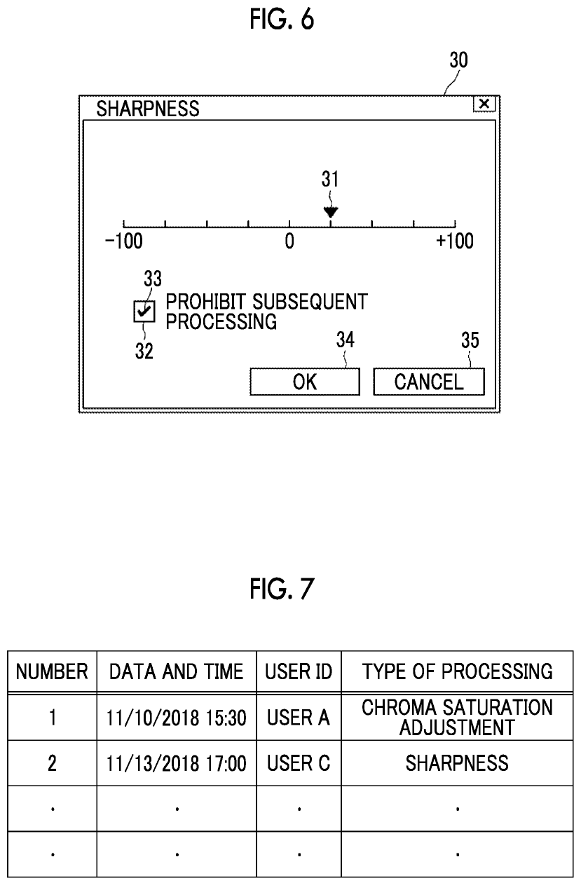

FIG. 6 is a diagram showing an example of screen display at the time of the image processing in the image processing apparatus according to a second embodiment, and FIG. 7 is an explanatory diagram of a list of prohibition of the image processing in the image processing apparatus according to the second embodiment.

FIG. 6 shows a window 30 at the time of sharpness editing as an example of a window displayed in a case in which the instruction of the image processing is input in the terminal 4. The window 30 comprises a slider 31 for sharpness adjustment, a check box 32, an OK button 34, and a cancel button 35.

The editor operates the slider 31 for sharpness adjustment to adjust to desired setting. In a case in which the editor does not want to change the setting of the same types of the image processing after editing by him/herself, the editor selects the check box 32 of “prohibit subsequent processing” to add a check 33. In a case in which the OK button 34 is selected by the editor in this state, the control unit 23 of the image processing apparatus 10 stores the processing of sharpness in a list of prohibition shown in FIG. 7 assuming that the prohibition instruction to prohibit this sharpness as the specific image processing is issued. As shown as an example in FIG. 7, this list of prohibition includes four items of a list number, the date and time when the prohibition instruction is issued, the user ID that issues the instruction, and a type of the specific image processing. The list of prohibition is stored in the storage 14.

Note that in a case in which the cancel button 35 is selected by the editor in the window 30, sharpness editing is terminated.

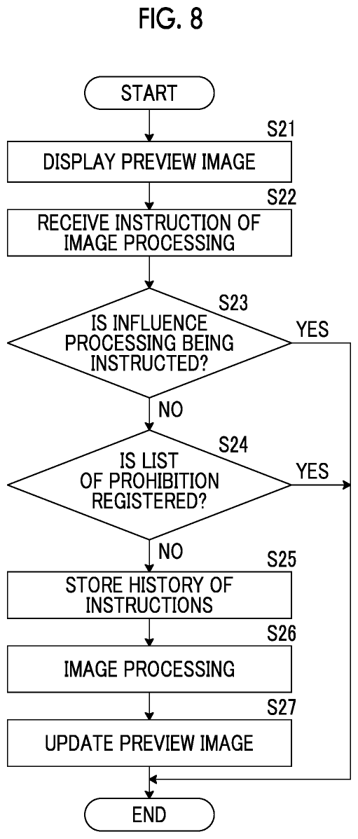

Next, in the present embodiment, a process flow when the image processing apparatus 10 receives the instruction of the image processing from each terminal 4 will be described. FIG. 8 is a flowchart describing the process flow when the image processing apparatus 10 according to the second embodiment receives the instruction of the image processing.

First, the image processing unit 22 develops the RAW image data in accordance with the preset initial parameter and displays the developed RAW image data on the terminal 4 as the preview image (step S21). Thereafter, in a case in which the instruction of the image processing is received in the image processing apparatus 10 from the terminal 4, the control unit 23 receives the instruction of the image processing from the terminal 4 (step S22), and performs determination whether the image processing that affects this instruction (that is, influence processing) is being currently instructed by another terminal 4 (step S23).

In a case in which it is determined in step S23 that the image processing that affects the instruction of the image processing received in step S22 is currently instructed by another terminal 4 (determination result Yes), the control unit 23 performs control of not causing the image processing unit 22 to perform the image processing in accordance with the instruction that affects the earliest instruction and causing the image processing unit 22 to terminate the image processing in accordance with the instruction from the terminal 4.

In a case in which it is determined in step S23 that the image processing that affects the instruction of the image processing received in step S22 is not being currently instructed by another terminal 4 (determination result No), the control unit 23 performs determination whether the image processing received in step S22 is registered in the list of prohibition (step S24).

In a case in which it is determined in step S24 that the image processing received in step S22 is registered in the list of prohibition (determination result Yes), the control unit 23 performs control of completing the image processing in accordance with the instruction from the terminal 4.

In a case in which it is determined in step S24 that the image processing received in step S22 is not registered in the list of prohibition (determination result No), the control unit 23 performs a process of storing the instruction of the image processing received in step S22 in the history of the instruction (step S25).

Next, the image processing unit 22 performs the image processing on the RAW image data based on the instruction of the image processing received in step S22 (step S26), updates the preview image to the content that reflects the image processing, and displays the updated preview image on the terminal 4 (step S27), and the process is terminated.

In the image processing apparatus 10 according to the present embodiment, the same effect as that of the first embodiment can also be obtained. Further, in a case in which the terminal 4 issues the prohibition instruction to prohibit the specific image processing on the RAW image data, the control unit 23 further performs control of prohibiting the specific image processing, for which the prohibition instruction is issued, on the RAW image data, so that it is possible to prevent the parameter of the desired image processing in a case in which collaborative editing of the image data is performed from being inadvertently erroneously edited.

### Third Embodiment

Hereinafter, a third embodiment of the present disclosure will be described. In the following, the difference from the first embodiment will be mainly described, and the description of the contents overlapping with the first embodiment will be omitted.

The difference between the third embodiment and the first embodiment is that, in a case in which the terminal 4 issues the instruction of the specific image processing on the RAW image data and the instruction of relation image processing having relevance to the specific image processing is stored in the history, the control unit 23 of the image processing apparatus 10 according to the third embodiment further perform control of transmitting caution information to the terminal 4 that transmits the instruction of the specific image processing.

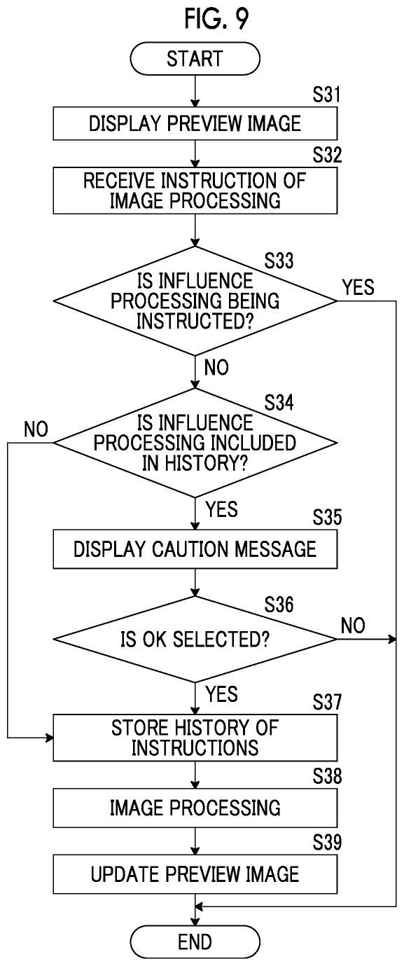

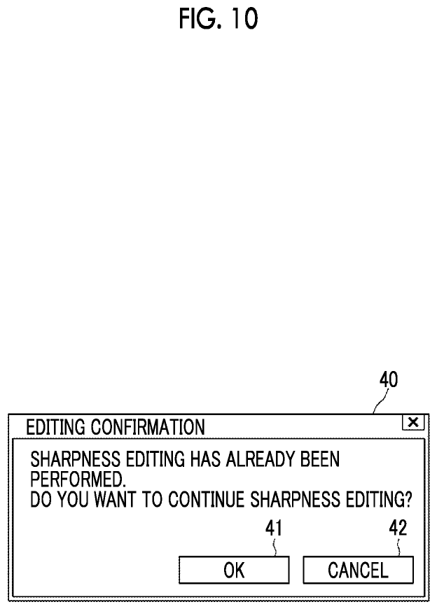

In the present embodiment, a process flow when the image processing apparatus 10 receives the instruction of the image processing from each terminal 4 will be described. FIG. 9 is a flowchart describing a process flow when an image processing apparatus 10 according to the third embodiment receives the instruction of the image processing, and FIG. 10 is a diagram showing an example of screen display at the time of the image processing in the image processing apparatus 10 according to the third embodiment.

First, the image processing unit 22 develops the RAW image data in accordance with the preset initial parameter and displays the developed RAW image data on the terminal 4 as the preview image (step S31). Thereafter, in a case in which the instruction of the image processing is received in the image processing apparatus 10 from the terminal 4, the control unit 23 receives the instruction of the image processing from the terminal 4 (step S32), and performs determination whether the image processing that affects this instruction (that is, influence processing) is being currently instructed by another terminal 4 (step S33).

In a case in which it is determined in step S33 that the image processing that affects the instruction of the image processing received in step S32 is currently instructed by another terminal 4 (determination result Yes), the control unit 23 performs control of not causing the image processing unit 22 to perform the image processing in accordance with the instruction that affects the earliest instruction and causing the image processing unit 22 to terminate the image processing in accordance with the instruction from the terminal 4.

In a case in which it is determined in step S33 that the image processing that affects the instruction of the image processing received in step S32 is not being currently instructed by another terminal 4 (determination result No), the control unit 23 performs determination whether the instruction of the relation image processing having relevance to the image processing (corresponding to the specific image processing) received in step S32 is stored in the history storage unit 24 (step S34).

Here, the “relation image processing having relevance to the specific image processing” means processing in which a result of one image processing affects a result of another image processing even in a case of the same types of the image processing or the different types of the image processing. Where, even in a case in which it is the image processing of the same type, it is not regarded as the relation image processing having relevance in a case in which the image processing is performed on regions different from each other. Further, even in the case of the same types of the image processing or even in the case of the processing in which the result of one image processing affects the result of another image processing even in a case of the different types of the image processing, in a case in which an adjustment amount of the parameter in the relation image processing is equal to or less than a preset threshold value, it may not be regarded as the relation image processing having relevance.

In a case in which it is determined in step S34 that the instruction of the relation image processing having relevance to the specific image processing is stored in the history storage unit 24 (determination result Yes), the control unit 23 performs control of transmitting the caution information to the terminal 4 which transmits the instruction of the specific image processing and displays the caution information in the terminal 4 as shown in FIG. 10 (step S35).

In FIG. 10, a window 40 of “editing confirmation” is shown as an example of a window showing the caution information displayed in the terminal 4. Here, an example of a case in which sharpness is instructed as the specific image processing is shown. The window 40 displays a message of “sharpness editing has already been performed. Do you want to continue sharpness editing?” as the caution information in the window, and comprises an OK button 41 and a cancel button 42.

The control unit 23 performs determination whether the OK button 41 of the window 40 displayed in step S35 is selected (step S36), and in a case in which it is determined that the OK button 41 is not selected (that is, the cancel button 42 is selected) (determination result No), performs control of completing the image processing in accordance with the instruction from the terminal 4.

In a case in which it is determined in step S36 that the OK button 41 is selected (determination result Yes), the control unit 23 performs a process of storing the instruction of the image processing received in step S32 in the history of the instruction (step S37).

Next, the image processing unit 22 performs the image processing on the RAW image data based on the instruction of the image processing received in step S32 (step S38), updates the preview image to the content that reflects the image processing, and displays the updated preview image on the terminal 4 (step S39), and the process is terminated.

Further, in a case in which it is determined in step S34 that the instruction of the relation image processing having relevance to the specific image processing is not stored in the history storage unit 24 (determination result No), the control unit 23 shifts to the process of step S37.

In the image processing apparatus 10 according to the present embodiment, the same effect as that of the first embodiment can also be obtained. Further, in a case in which the terminal 4 issues the instruction of the specific image processing on the RAW image data and the instruction of the relation image processing having relevance to the specific image processing is stored in the history, the control unit 23 further perform control of transmitting the caution information to the terminal 4 that transmits the instruction of the specific image processing, so that it is possible to prevent the parameter of the desired image processing in a case in which collaborative editing of the image data is performed from being inadvertently erroneously edited.

### Modification Example

Although the present disclosure has been described above based on the preferred embodiments thereof, embodiments to which the present disclosure can be applied are not limited to the embodiments described above.

For example, the original image data handled by the image processing apparatus according to the present disclosure is not limited to the RAW image data, and may be any image data, such as high resolution rendering image data.

It is needless to say that the present disclosure can be modified as appropriate without departing from the gist of the present disclosure in addition to the above. Also, the presently disclosed technology extends to a storage medium that non-temporarily stores the program, in addition to the program.

The disclosure of JP2019-064783A filed on Mar. 28, 2019 is incorporated in the present specification by reference in its entirety. All documents, patent applications, and technical standards described in the present specification are incorporated in the present specification by reference to the same extent as a case in which individual document, patent application, and technical standard are specifically and individually noted to be incorporated by reference.

What is claimed is:

1. An image processing apparatus that performs image processing on original image data based on an instruction from a terminal, the apparatus comprising:
a communication unit that performs communication with the terminal;
a storage that stores a history of the instruction for the image processing on the original image data; and
a processor,
wherein the processor
acquires the original image data,
performs the image processing as instructed by the terminal on the original image data,
performs, in a case in which one instruction affects another instruction among a plurality of the instructions with respect to the original image data, control of not performing the image processing in accordance with an instruction that affects a highest priority instruction,
performs the image processing based on the history stored in the storage, and
changes order of performing the image processing based on the history stored in the storage.

2. The image processing apparatus according to claim 1,
wherein the highest priority instruction is an earliest instruction.

3. The image processing apparatus according to claim 1,
wherein the highest priority instruction is an instruction from the terminal set to a highest priority.

4. The image processing apparatus according to claim 1,
wherein the processor performs a plurality of the same types of the image processing in one image processing based on the history stored in the storage.

5. The image processing apparatus according to claim 1,
wherein in a case in which the terminal issues a prohibition instruction to prohibit specific image processing on the original image data, the processor performs control of prohibiting the specific image processing, for which the prohibition instruction is issued, on the original image data.

6. The image processing apparatus according to claim 1,
wherein in a case in which the terminal issues an instruction of specific image processing on the original image data and an instruction of relation image processing having relevance to the specific image processing is stored in the history, the processor transmits caution information to the terminal which transmits the instruction of the specific image processing.

7. The image processing apparatus according to claim 1,
wherein the original image data is RAW image data, and
the image processing performed by the processor includes development treatment on the RAW image data.

8. A control method of an image processing apparatus that performs image processing on original image data based on an instruction from a terminal, the method comprising:
a communication step of performing communication with the terminal;
an acquisition step of acquiring the original image data;
a first image processing step of performing the image processing as instructed by the terminal on the original image data; and
a control step of performing, in a case in which one instruction affects another instruction among a plurality of the instructions with respect to the original image data, control of not performing the image processing in accordance with an instruction that affects a highest priority instruction,
a second image processing step of performing the image processing based on the history stored in a storage that stores a history of the instruction for the image processing on the original image data, and
a change step of changing order of performing the image processing based on the history stored in the storage.

9. A non-transitory computer-readable storage medium storing a control program that controls an image processing apparatus that performs image processing on original image data based on an instruction from a terminal, the program causing a computer to execute:
a communication step of performing communication with the terminal;
an acquisition step of acquiring the original image data;
a first image processing step of performing the image processing as instructed by the terminal on the original image data; and
a control step of performing, in a case in which one instruction affects another instruction among a plurality of the instructions with respect to the original image data, control of not performing the image processing in accordance with an instruction that affects a highest priority instruction,
a second image processing step of performing the image processing based on the history stored in a storage that stores a history of the instruction for the image processing on the original image data, and
a change step of changing order of performing the image processing based on the history stored in the storage.
